(19) United States
(12) Patent Application Publication
(10) Pub. No.: US 2010/0052912 A1
(43) Pub. Date: Mar. 4, 2010

(54) METHODS AND APPARATUS FOR AN ID CARD SECURITY SWITCH

(75) Inventors: Robert Arneson, Baltimore, MD (US); Mansoor Pasha, Gaithersburg, MD (US); Nilan Solanki, Columbia, MD (US)

Correspondence Address: MOTOROLA, INC., 1303 EAST ALGONQUIN ROAD, IL01/3RD, SCHAUMBURG, IL, 60196, US

(73) Assignee: SYMBOL TECHNOLOGIES, INC., Holtsville, NY (US)

(21) Appl. No.: 12/201,177

(22) Filed: Aug. 29, 2008

(51) Int. Cl. G08B 13/14

(52) U.S. Cl. 340/572.7; 340/572.8

(57) ABSTRACT

To prevent the unwanted activation and/or reading of data within an ID card, a manually actuatable switch, such as a slider switch, is provided (e.g., along an edge of the card) to allow the user to selectively activate and deactivate an operational characteristic of the card. The “operational characteristic” of the card might include, for example, power on/off, the ability to respond to external signals, operation of the RF antenna, the transfer of data, and/or any other operational characteristics that assists in preventing unwanted access.

### TECHNICAL FIELD

The present invention generally relates to personal identification cards such as smartcard, RFID cards, and the like, and, more particularly, to methods of preventing undesired acquisition of data within such cards.

### BACKGROUND

Smartcard technology has achieved wide popularity in much of the world, in part because such cards—which typically include an integrated circuit, a memory, and the like—conveniently allow the user to carry a significant amount of personal information in a fairly compact space.

At the same time, RFID technology has also made significant advances in recent years, and has resulted in the deployment of significant infrastructure in the form of RFID readers, RFID tags, etc. As a result, identification cards (“ID cards”) of various types increasingly include some form of RFID technology to assist in interfacing with external card reader equipment, providing data transfer, identification of the user, and locationing of the bearer while in the vicinity of RFID readers. One such ID card is disclosed in U.S. Pat. No. 6,972,252.

Nevertheless, many people remain troubled by the ease with which a third party—benevolent or not—could acquire information about the user while that user is carrying such an ID card. For example, a public space with pervasive RFID readers could be used, with relative ease, to track the movement and activities of that individual. Furthermore, there is a concern that personal information stored on the card could be stolen, altered, or erased by hackers or other individuals. Most cards include passive or active RFID elements that are never in an actual “off” state, and thus the user can never actually prevent activation of the card.

Accordingly, it is desirable to provide enhanced security ID cards that prevent unwanted reading of such cards for the purposes of identification, data theft, or locationing. Furthermore, other desirable features and characteristics of the present invention will become apparent from the subsequent detailed description and the appended claims, taken in conjunction with the accompanying drawings and the foregoing technical field and background.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of typical card useful in describing the present invention;

FIGS. 2A and 2B are conceptual diagrams of a RF antenna incorporated into an ID card in accordance with one embodiment of the present invention; and

FIG. 3 is a side view of an ID card in accordance with one embodiment of the present invention.

### DETAILED DESCRIPTION

The present invention generally relates to an ID card incorporating a security switch that allows the bearer of the card to manually disable and enable an operational characteristic of the card—e.g., by enabling and disabling an RF antenna used by the card for communication. In this regard, the following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention. For the sake of brevity, conventional techniques related to smartcards, signal processing, data transmission, signaling, network control, the 802.11 family of specifications, RFID systems, etc. may not be described in detail herein.

In accordance with the present invention, an ID card of the type including an RF antenna includes a mechanism for allowing a user to manually deactivate and activate an operational feature of the card. In this regard, as a threshold matter, it should be appreciated that the present invention may be incorporated into any type of card, with any particular size and shape. While the description that follows often refers to standard Smartcards and other popular types of ID cards, the present invention is not so limiting.

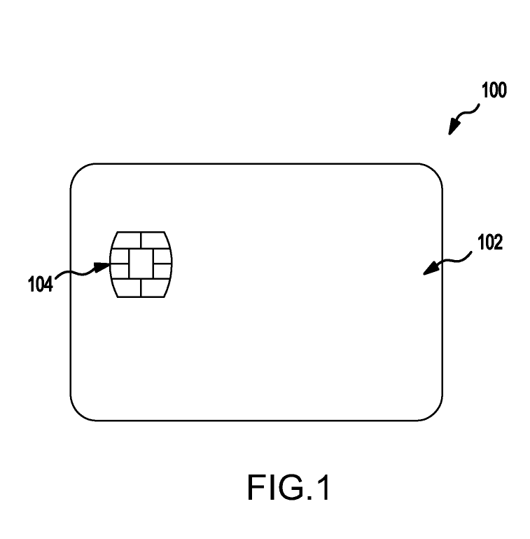

Without loss of generality, and referring to FIG. 1, an exemplary ID card 100 of the conventional smartcard type generally includes a rectangular body 102 and one or more contacts 104 providing I/O to a card reader, etc. The card typically includes hardware, software, and firmware that together provide the desired functionality. For example, conventional smartcards include an integrated circuit, memory, I/O controllers, etc. (not shown). In one embodiment, however, card 100 does not contain contacts 104, but instead includes RFID functionality to provide data communication with external components, and is activated by an external signal such as would be received by a conventional RF reader. As mentioned above, the present invention can be used with contact-based, contactless, and hybrid cards.

The memory within ID card 100 may be used to store a significant amount of information relating to the bearer of the card, including, for example, name, address, phone number, credit and debit card numbers, health data, loyalty program data, biometric data, etc. Furthermore, to the extent that ID card 100 incorporates an RFID component, its location can be tracked by RFID readers in its vicinity.

To prevent the unwanted activation and/or reading of data within ID card 100, a manually actuatable switch (or simply “switch”) is provided to allow the user to selectively activate and deactivate an operational characteristic of the card. The “operational characteristic” of the card might include, for example, power on/off, the ability to respond to external signals, the transfer of data, and/or any other operational characteristics that assists in preventing unwanted access.

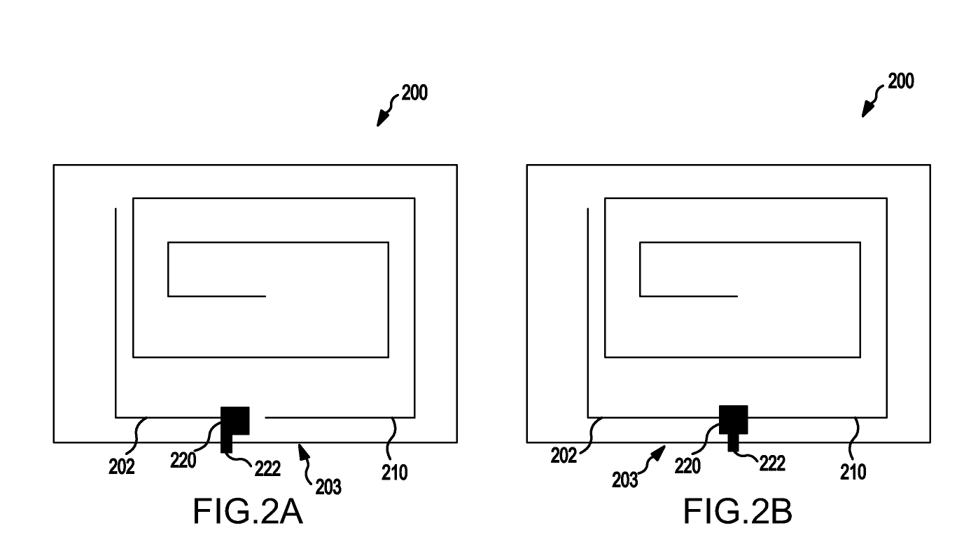

Referring to FIGS. 2A and 2B, for example, an RF component 200 located within ID card 100 is shown. RF component 200 includes an antenna coil or simply “antenna” 210 (shown here in a spiral rectangular configuration) that is used to activate ID card 100 and provide for input and output of data. RF component 200 also includes a ground contact or line 202. RF component 200 may provide communication in accordance with the ISO 10536 and ISO 14443 contactless card standards, for example, or may use any convenient communication and activation scheme. Other components such as rectifier circuits, limiter circuits, clock/modulation circuits, will typically be coupled to RF component 200 in the conventional manner, but for the purposes of clarity are not described in detail herein.

In the illustrated embodiment, a manually actuatable switch 203 includes a slider switch 220 that has two primary positions: a first position, as shown in FIG. 2A, and a second position as shown in FIG. 2B. Slider switch 220 preferably includes a projecting feature 222 that allows manual manipulation by the user.

In the first position (FIG. 2A), the RF component 200 is not grounded, and antenna 210 is not connected. This corresponds to the “off” (or disabled) position. In the second position (FIG. 2B), the RF component 200 is grounded, and antenna 210 is connected. This corresponds to the “on” (or enabled) position.

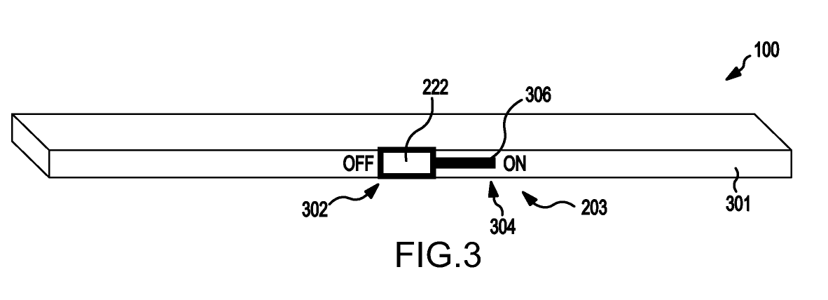

A side view of the exemplary embodiment is illustrated in FIG. 3. As shown, switch 203 is provided on an edge 301 of ID card 100. Projecting feature 222 is preferably large enough that it can be manipulated between “off” position 302 and “on” position 304, while not interfering substantially with the size and functionality of ID card 100.

While FIGS. 2A, 2B, and 3 illustrate a slider-type switch, it will be appreciated that a variety of manually actuatable switches 203 may be employed, including toggle buttons and any other suitable mechanism that can be set to at least two positions.

Furthermore, whereas the illustrated embodiment is discussed in the context of enabling and disabling an RF antenna, manually actuatable switch 203 may be used to control any other operational characteristic of ID card 100.

It should be appreciated that the example embodiment or embodiments described herein are not intended to limit the scope, applicability, or configuration of the invention in any way. For example, these methods may be used in connection with standard barcode readers and the like. In general, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. An ID card comprising:
a card body;
an RF antenna provided within the card body and configured to communicate with an external device; and
a manually actuatable switch configured to selectively enable and disable the RF antenna.

2. The ID card of claim 1, wherein the manually actuatable switch comprises a slider switch.

3. The ID card of claim 2, wherein the slider switch is located on an edge of the card body.

4. The ID card of claim 1, wherein the RF antenna is configured to communicate with the external device in accordance with a contactless card standard.

5. The ID card of claim 1, wherein the manually actuatable switch has an “on” position corresponding to the RF antenna being enabled, and an “off” position corresponding to the RF antenna being disabled, further wherein the manually actuatable switch connects the RF antenna to a ground node in the “on” state, and disconnects the RF antenna to the ground node in the “off” state.

6. A method of providing security for an ID card of the type having an RF antenna incorporated therein, the method comprising:
providing a manually actuatable switch on an exterior surface of the ID card having a first position and a second position.
activating the RF antenna when the manually actuatable switch is in the first position; and
deactivating the RF antenna when the manually actuatable switch is in the second position.

7. The method of claim 6, wherein the providing step includes providing a slider switch located on an edge of the ID card.

8. The method claim 6, wherein, when in the first position, the RF antenna is configured to communicate with the external device in accordance with a contactless card standard.

7. An ID card comprising:
a generally rectangular card body;
an RF antenna disposed within the generally rectangular card body and configured to communicate with an external device in accordance with a contactless card standard;
a switch provided on an edge of the generally rectangular card body, the switch configured to selectively activate and deactivate the RF antenna.

8. The ID card of claim 7, wherein the switch is a slider switch having a first position and a second position.

9. The ID card of claim 8, wherein the switch connects the RF antenna to a ground node when in the first position, and disconnects the RF antenna to the ground node when in the second position.
